(19) United States
(12) Patent Application Publication
(10) Pub. No.: US 2022/0292652 A1
(43) Pub. Date: Sep. 15, 2022

(54) IMAGE GENERATION METHOD AND INFORMATION PROCESSING DEVICE

(71) Applicant: SEIKO EPSON CORPORATION, Tokyo (JP)

(72) Inventors: Kota TAKEUCHI, Matsumoto-shi (JP); Hiroyuki ICHIEDA, Matsumoto-shi (JP)

(73) Assignee: SEIKO EPSON CORPORATION, Tokyo (JP)

(21) Appl. No.: 17/691,329

(22) Filed: Mar. 10, 2022

(30) Foreign Application Priority Data
Mar. 11, 2021 (JP) 2021-039001

(51) Int. Cl. G06T 5/00; G06T 5/50; G06T 11/00; G09G 3/00

(52) U.S. Cl. CPC G06T 5/006; G06T 5/50; G06T 11/00; G09G 3/002; G09G 2354/00; G09G 2320/0693; G09G 2340/0464

(57) ABSTRACT

The image generation method includes the steps of outputting a first image to a projector, obtaining a taken image obtained by imaging a projection surface on which a projection image based on the first image is projected by the projector, detecting, from the taken image, a first projection area of the projection surface on which the projection image is projected, generating a first adjusting image obtained by superimposing an icon or a plurality of icons representing a correction direction of one of correction target points on a contour of the first projection area on the taken image, making a display device display the first adjusting image, and generating a second image based on a second position when an instruction of moving the one of the correction target points from a first position to the second position with respect to the icon or the plurality of icons is received.

The present application is based on, and claims priority from JP Application Serial Number 2021-039001, filed Mar. 11, 2021, the disclosure of which is hereby incorporated by reference herein in its entirety.

### BACKGROUND

### 1. Technical Field

The present disclosure relates to an image generation method and an information processing device.

### 2. Related Art

When projecting an image on a screen from a projector, the image to be projected on the screen is distorted in accordance with an angle formed between a light axis of projection light and the screen. Typically, a shape of an outer frame of the image to be projected on the screen becomes a trapezoid. As a method of correcting the shape of the image to be projected on the screen, there has been known a keystone correction. The keystone correction means a correction method of electronically canceling a distortion of the image to be projected at the time point before the projection.

In JP-A-2019-125955 (Document 1), there is disclosed a method of executing the keystone correction while checking a screen on an information terminal to transmit a correction instruction to the projector.

However, in a technology related to Document 1, the screen displayed on the information terminal is nothing more than what displays in advance an outer shape to be a target of an outline adjustment result of a projection area on a projection surface on which the projector projects an image such as a still image or a moving image. In other words, there is a problem that it is unachievable to execute the correction while checking in advance the outer shape of the projection area on which the correction has been reflected.

### SUMMARY

An image generation method according to an aspect of the present disclosure includes the steps of outputting a first image to a projector, obtaining a taken image obtained by imaging a projection surface on which a projection image based on the first image is projected by the projector, detecting, from the taken image, a first projection area of the projection surface on which the projection image is projected, generating a first adjusting image which is obtained by superimposing an icon or a plurality of icons on the taken image, wherein the icon or the plurality of icons are disposed so as to correspond to one of the correction target points on a contour of the first projection area, and represent the correction direction of the one of the correction target points, making a display device display the first adjusting image, and generating a second image based on the position of the one of the correction target points which was moved when the instruction of moving the one of the correction target points with respect to the icon or the plurality of icons is received.

Further, an image generation method according to an aspect of the present disclosure is an image generation method of outputting the second image generated by the image generation method described above to the display device.

Further, an information processing device according to another aspect of the present disclosure includes a first image output section configured to output a first image to a projector, a taken image acquisition section configured to obtain a taken image obtained by imaging a projection surface on which a projection image based on the first image is projected by the projector, a projection area detection section configured to detect, from the taken image, a first projection area of the projection surface on which the projection image is projected, a first adjusting image generation section configured to generate a first adjusting image which is obtained by superimposing an icon or a plurality of icons on the taken image, wherein the icon or the plurality of icons are disposed so as to correspond to one of the correction target points on a contour of the first projection area, and represent the correction direction of the one of the correction target points, a display control section configured to make a display device display the first adjusting image, a second image generation section configured to generate a second image based on the position of the one of the correction target points which was moved when an instruction of moving the one of the correction target points with respect to the icon or the plurality of icons is received, and a second image output section configured to output the second image to the projector.

### BRIEF DESCRIPTION OF THE DRAWINGS

FIG. 1 is a block diagram showing an information processing system 1 according to a first embodiment.

FIG. 2 is a block diagram showing a configuration of an information processing device according to the first embodiment.

FIG. 3 is a diagram showing a detection example of interest points of each of a camera image and a panel image.

FIG. 4A is a diagram showing an example of a first adjusting image.

FIG. 4B is a diagram showing an example of the first adjusting image.

FIG. 4C is a diagram showing an example of a second adjusting image.

FIG. 4D is a diagram showing an example of the first adjusting image.

FIG. 4E is a diagram showing an example of the second adjusting image.

FIG. 4F is a diagram showing an example of the first adjusting image.

FIG. 4G is a diagram showing an example of the second adjusting image.

FIG. 5A is a diagram showing an example of the first adjusting image.

FIG. 5B is a diagram showing an example of the first adjusting image.

FIG. 5C is a diagram showing an example of the first adjusting image.

FIG. 5D is a diagram showing an example of the second adjusting image.

FIG. 5E is a diagram showing an example of the second adjusting image.

FIG. 6 is a diagram showing an example of the second adjusting image.

FIG. 7 is a block diagram showing a configuration of a projector 20 according to the first embodiment.

FIG. 8 is a flowchart showing an operation of the information processing system 1 according to the first embodiment.

FIG. 9 is a block diagram showing a configuration of an information processing device 10A according to a second embodiment.

FIG. 10 is a block diagram showing a configuration of a projector 20A according to the second embodiment.

### DESCRIPTION OF EXEMPLARY EMBODIMENTS

An image generation method, a control method, and an information processing device according to some embodiments will hereinafter be described with reference to the drawings. It should be noted that in each of the drawings, the size and the scale of each of the constituents are arbitrarily made different from actual ones. Further, although the embodiments described below are preferable specific examples, and are therefore provided with a variety of technically preferable limitations, the scope of the present disclosure is not limited to these embodiments unless the description to limit the present disclosure is particularly presented in the following description.

### 1. First Embodiment

### 1-1: Overall Configuration

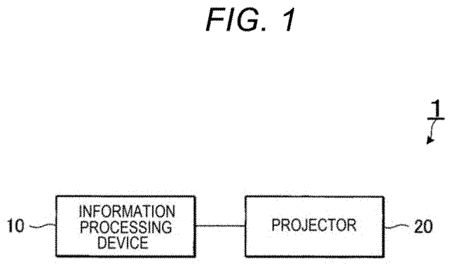

FIG. 1 is a block diagram showing a configuration of an information processing system 1 according to a first embodiment. The information processing system 1 is a system which more efficiently performs a manual adjustment of an outer shape of a projection area by a projector 20 described later than ever before with an operation in an information processing device 10 described later.

The information processing system 1 is provided with the projector 20 which projects an image such as a still image or a moving image on a plane such as a screen or a wall. It should be noted that although the projector 20 is illustrated alone as the projector provided to the information processing system 1 in FIG. 1, the embodiment of the present disclosure is not limited thereto. For example, in order to execute multiple projection, the information processing system 1 can be provided with a plurality of projectors 20.

Further, the information processing system 1 is provided with the information processing device 10. The information processing device 10 outputs a first image which is the basis for a projection image to be projected by the projector 20 to that projector 20. When projecting the image on the screen, it is desirable to change a shape of the projection area in accordance with a request from the user irrespective of a shape of the screen in some cases. In such cases, the information processing device 10 corrects the shape of the projection area in accordance with an operation by the user. Specifically, the information processing device 10 newly generates a second image to be output to the projector 20 based on a correction instruction by the user with respect to the shape of the projection area.

### 1-2: Configuration of Information Processing Device

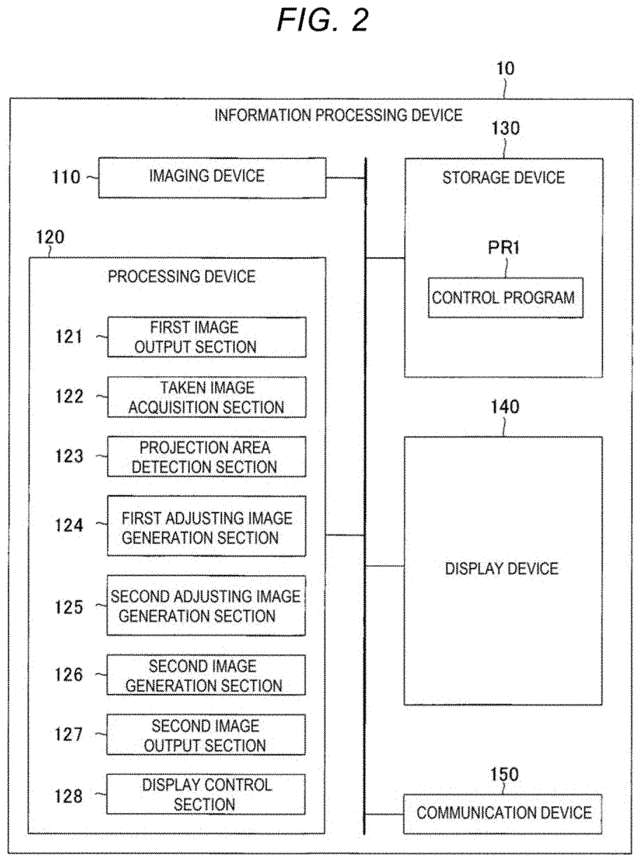

FIG. 2 is a block diagram showing a configuration example of the information processing device 10. The information processing device 10 is a PC as a typical example, but is not limited thereto, and can be, for example, a tablet terminal or a smartphone. The information processing device 10 is provided with an imaging device 110, a processing device 120, a storage device 130, a display device 140, and a communication device 150. The constituents of the information processing device 10 are coupled to each other with a single bus or a plurality of busses for communicating information.

The imaging device 110 takes an image of a projection surface on which the projection image based on the first image output from the information processing device 10 to the projector 20 is projected by the projector 20. The imaging device 110 takes a variety of images under control by the processing device 120. For example, a WEB camera provided to the PC, the tablet terminal, and the smartphone is favorably used as the imaging device 110, but this is not a limitation, and the imaging device 110 can be an external camera.

The processing device 120 is a processor for controlling the whole of the information processing device 10, and is constituted by, for example, a single chip or a plurality of chips. The processing device 120 is formed of a central processing device (CPU: Central Processing Unit) including, for example, an interface with peripheral devices, an arithmetic device, and registers. It should be noted that some or all of the functions of the processing device 120 can also be realized by hardware such as a DSP (Digital Signal Processor), an ASIC (Application Specific Integrated Circuit), a PLD (Programmable Logic Device), or an FPGA (Field Programmable Gate Array). The processing device 120 executes a variety of types of processing in parallel or in sequence.

The storage device 130 is a recording medium which can be read by the processing device 120, and stores a plurality of programs including a control program PR1 to be executed by the processing device 120, the first image described above which is output by the information processing device 10 to the projector 20, and the second image described above which is generated by the information processing device 10 using a method described later. The storage device 130 can be formed of at least one of, for example, a ROM (Read Only Memory), an EPROM (Erasable Programmable ROM), an EEPROM (Electrically Erasable Programmable ROM), or a RAM (Random Access Memory). The storage device 130 can be called a register, a cache, a main memory, a main storage unit, and so on.

The display device 140 is a device for displaying an image and character information. The display device 140 displays a variety of images under the control by the processing device 120. A variety of types of display panel such as a liquid crystal display panel or an organic EL (Electro Luminescence) display panel is favorably used as the display device 140.

The communication device 150 is hardware as a transmitting and receiving device for performing communication with other devices. In particular, in the present embodiment, the communication device 150 is a communication device used for connecting the information processing device 10 to the projector 20 with wire or wirelessly. The communication device 150 is also called, for example, a network device, a network controller, a network card, and a communication module.

The processing device 120 retrieves the control program PR1 from the storage device 130 and then executes the control program PR1 to thereby function as a first image output section 121, a taken image acquisition section 122, a projection area detection section 123, a first adjusting image generation section 124, a second adjusting image generation section 125, a second image generation section 126, a second image output section 127, and a display control section 128. It should be noted that the control program PR1 can be transmitted from another device such as a server for managing the information processing device 10 via a communication network not shown.

The first image output section 121 outputs the first image to be stored in the storage device 130 to the projector 20.

The taken image acquisition section 122 obtains a taken image obtained by imaging the projection surface on which the projection image based on the first image is projected by the projector 20.

The projection area detection section 123 detects a first projection area in the projection surface on which the projection image is projected from the taken image obtained by the taken image acquisition section 122.

In particular, on this occasion, the projection area detection section 123 detects correspondence between interest points of the taken image taken by the taken image acquisition section 122 and interest points of the first image output to the projector 20, and then calculates a projective transform matrix between a coordinate of the taken image and a coordinate of the first image based on the detection result. It should be noted that, hereinafter, the taken image is called a “camera image,” the coordinate of the taken image is called a “camera coordinate,” the first image is called a “panel image,” and the coordinate of the first image is called a “panel coordinate” in some cases.

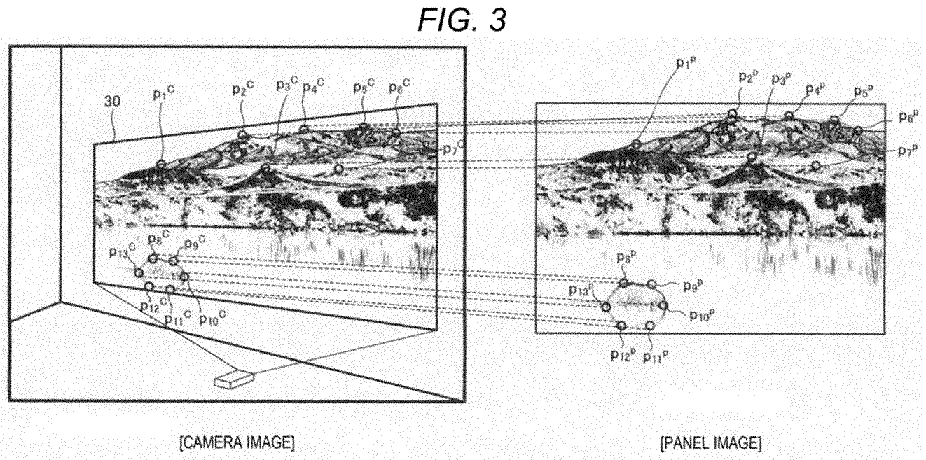

FIG. 3 shows a detection example of the interest points of each of the camera image and the panel image. In the example shown in FIG. 3, the projection area detection section 123 detects the interest points p₁^{c}, p₂^{c}, . . . , p₁₃^{c} from the camera image, and detects the interest points p₁^{p}, p₂^{p}, . . . , p₁₃^{p} from the panel image. It should be noted that it is preferable to use one or more of, for example, the FAST feature detection, the Harris and Stephens/Plessey corner detection algorithm, ORB, the Shi-Tomasi method, SURF, KAZE, and the MSER method as the detection method of the interest points.

Then, the projection area detection section 123 obtains the correspondence relationship between the interest points in the camera image and the interest points in the panel image. In the example shown in FIG. 3, the projection area detection section 123 obtains information representing the fact that the interest point p₁^{c} in the camera image and the interest point p₁^{p} in the panel image, the interest point p₂^{c} in the camera image and the interest point p₂^{p} in the panel image, . . . , the interest point p₁₃^{c} in the camera image and the interest point p₁₃^{p} in the panel image correspond to each other, respectively.

Then, the projection area detection section 123 obtains the projective transform matrix H from the coordinates of all of the interest points corresponding to each other using the following formula [1]. It should be noted that in the example shown in FIG. 3, the number of the interest points in each of the camera image and the panel image is 13, but in the formula [1], the number is generalized into N. Further, the coordinate of the interest point pₙ^{c} in the camera image is defined as (xₙ^{c},yₙ^{c}), and the coordinate of the interest point pₙ^{p} in the panel image is defined as (xₙ^{p}, yₙ^{p}). Where, n is an integer satisfying 1≤n≤N.

$$( \begin{matrix}{x}_{1}^{c} & & {x}_{N}^{c} \\ {y}_{1}^{c} & … & {y}_{N}^{c} \\ 1 & & 1\end{matrix} ) ∝ H ( \begin{matrix}{x}_{1}^{p} & & {x}_{N}^{p} \\ {y}_{1}^{p} & … & {y}_{N}^{p} \\ 1 & & 1\end{matrix} ) = ( \begin{matrix}{h}_{11} & {h}_{12} & {h}_{13} \\ {h}_{21} & {h}_{22} & {h}_{23} \\ {h}_{31} & {h}_{23} & {h}_{33}\end{matrix} ) ( \begin{matrix}{x}_{1}^{p} & & {x}_{N}^{p} \\ {y}_{1}^{p} & … & {y}_{N}^{p} \\ 1 & & 1\end{matrix} ) \qquad [ 1 ]$$

It is possible for the projection area detection section 123 to multiply the coordinates of the four corners of the panel image in the panel coordinate system by the projective transform matrix H to thereby calculate the coordinates of the four corners of a first projection area 30. More particularly, the projection area detection section 123 multiplies the coordinates of the four corners of the panel image in which the projection image is projected by the projective transform matrix H to thereby calculate the coordinates of the four corners of the first projection area 30 on the projection surface in the camera coordinate system. It is possible for the projection area detection section 123 to detect the first projection area 30 using this calculation result.

Since this projective transform matrix H is effective for all of the coordinates on the camera image thus taken and the panel image, it is possible to obtain what coordinate on the panel coordinate system corresponds to the coordinate of the point designated by the user in the camera coordinate system. More particularly, by a method including a step of multiplying the coordinate of the point designated by the user in the camera coordinate system by an inverse matrix H of the projective transform matrix H described above, it is possible to obtain where the coordinate is located in the panel coordinate system. Similarly, translation of correction target points 31 through 38 selected using icons 31H through 34H, 31V through 34V, 35H, 36V, 37H, and 38V described later on the camera image is obtained as translation in the panel coordinate system by the method including the step of multiplying each of the coordinates of the correction target points 31 through 38 which have not been translated and the coordinates of the correction target points 31 through 38 which have been translated by the inverse matrix H⁻¹ of the projective transform matrix H.

It should be noted that when the imaging device 110 is fixed, it is sufficient for the projective transform matrix H, or the inverse matrix H⁻¹ of the projective transform matrix H to be calculated based on the camera image and the panel image as still images at the time point when the imaging device 110 starts imaging. In contrast, when the imaging device 110 is not fixed, it is favorable for the projective transform matrix H or the inverse matrix H⁻¹ of the projective transform matrix H to be calculated for each frame imaged by the imaging device 110.

It should be noted that although the details will be described later, the whole of the inverse matrix H⁻¹ of the projective transform matrix H is called “parameters” in the present specification in some cases.

The projection area detection section 123 outputs the projective transform matrix H thus calculated to the first adjusting image generation section 124 described later, the second adjusting image generation section 125 described later, and the second image generation section 126 described later.

Further, in order to calculate the projective transform matrix H, it is possible to use an image specialized for the calculation of the projective transform matrix H separately from the panel image as the first image. More particularly, it is favorable for the projection area detection section 123 to calculate the projective transform matrix H in advance using the image specialized for the calculation of the projective transform matrix H in the anterior stage of the output of the first image to the projector 20.

A scenic picture is used as the camera image and the panel image in the example shown in FIG. 3, but this is not a limitation. For example, when calculating the projective transform matrix H, it is possible to use an image of a chessboard instead of the scenic picture. When using the chessboard image, the lattice coordinate in the panel coordinate system is known when generating the chessboard image to be projected on the panel, and therefore, by detecting lattice points from the chessboard image in the taken image, it is possible to obtain the lattice coordinate in the camera coordinate system. Subsequently, it is possible to calculate the projective transform matrix H from the correspondence relationship between the both lattice coordinates.

Further, the projection area detection section 123 outputs the first projection area 30 detected or calculated to the first adjusting image generation section 124 and the second adjusting image generation section 125.

The first adjusting image generation section 124 generates a first adjusting image which is obtained by superimposing an icon or a plurality of icons on the taken image taken by the imaging device 110, wherein the icon or the plurality of icons are disposed so as to correspond to one of the correction target points on the contour of the first projection area 30, and represents a correction direction of the one of the correction target points.

Further, when the second adjusting image generation section 125 receives an instruction of translating the one of the correction target points in the first adjusting image, the second adjusting image generation section 125 generates a second adjusting image including a second projection area obtained by correcting the first projection area based on the correction target point having been translated based on that instruction.

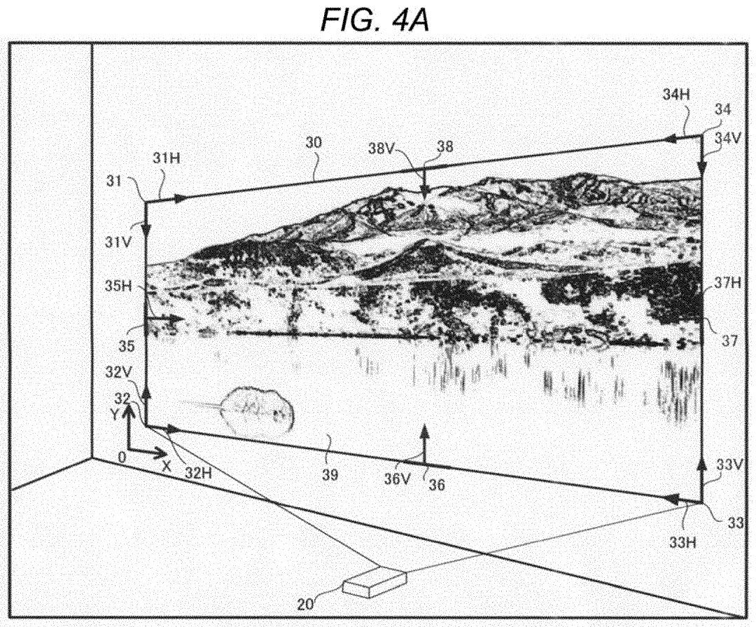

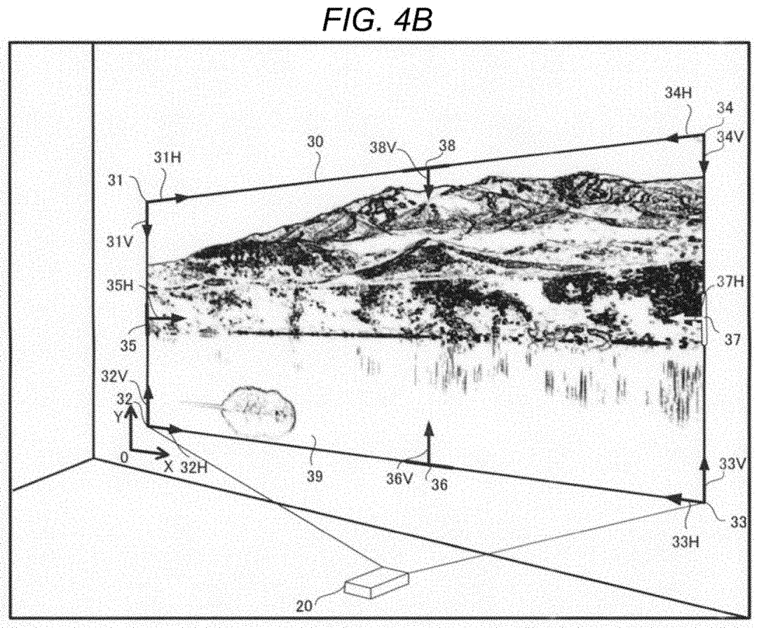

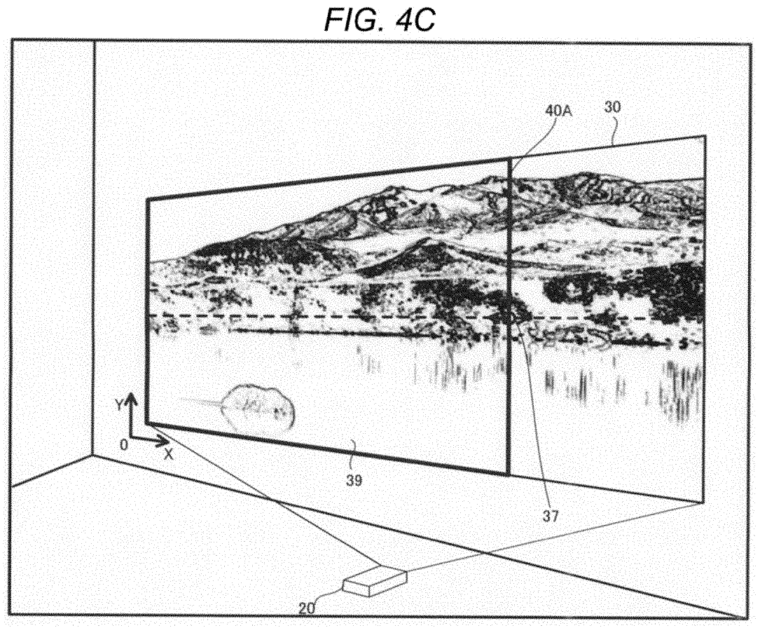

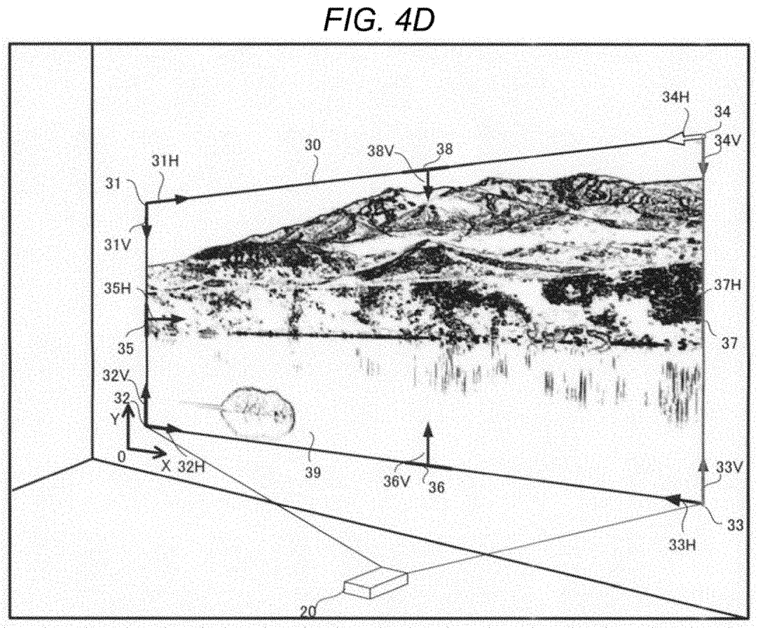

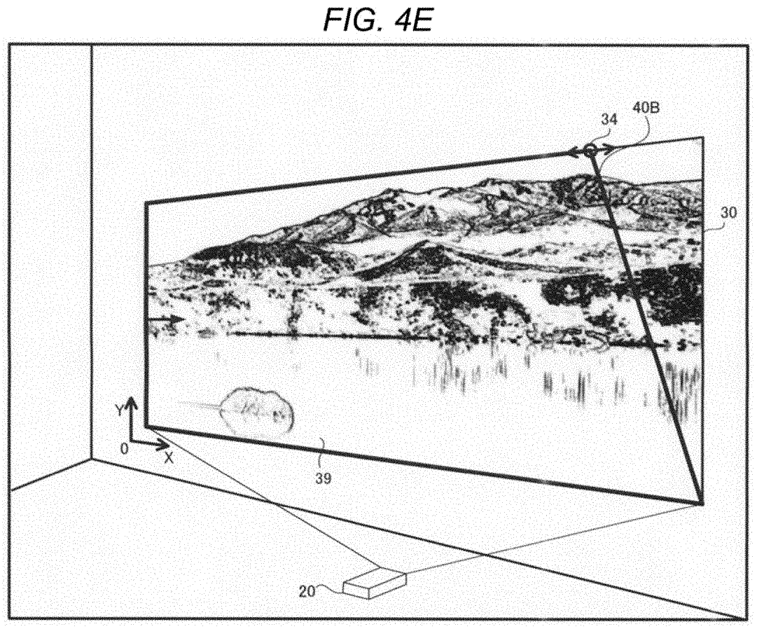

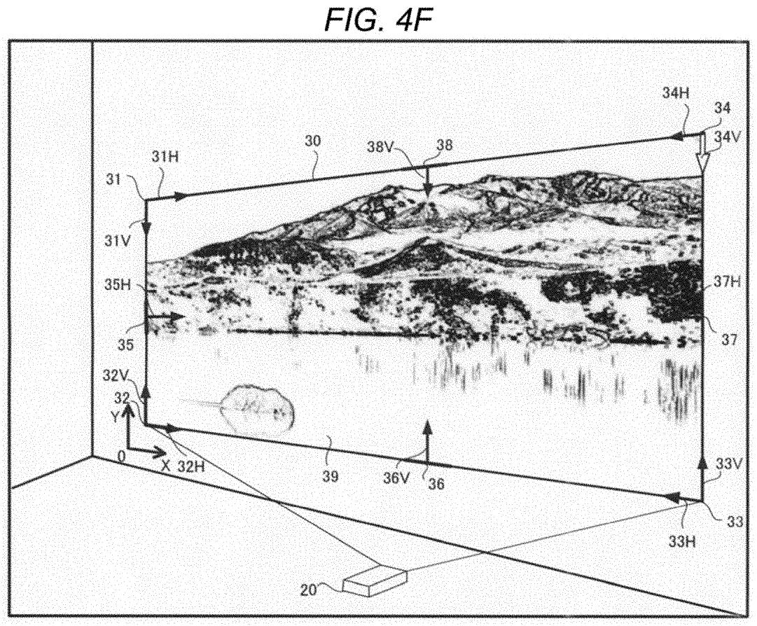

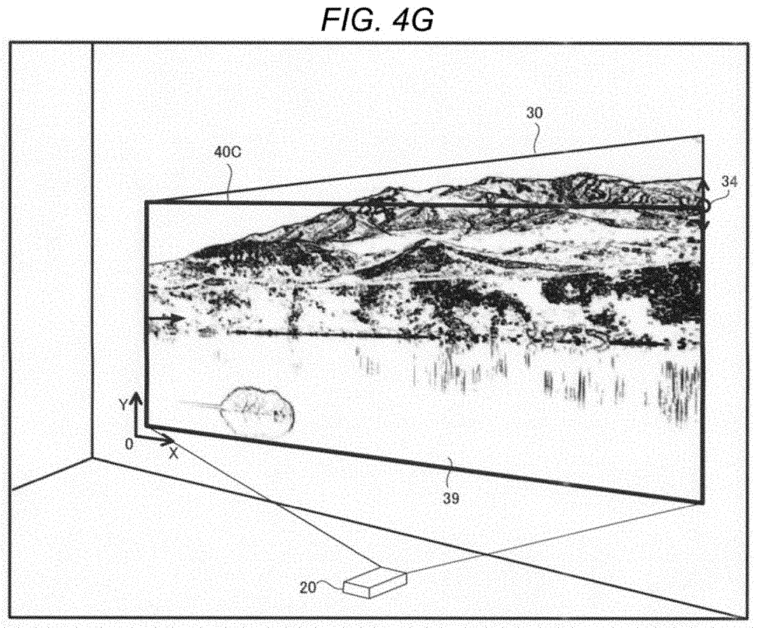

FIG. 4A through FIG. 4G show examples of the first adjusting image and the second adjusting image. More particularly, FIG. 4A, FIG. 4B, FIG. 4D, and FIG. 4F show examples of the first adjusting image, and FIG. 4C, FIG. 4E, and FIG. 4G show examples of the second adjusting image. The black frame in FIG. 4A is an outer frame representing an outer edge of the first projection area 30. The four vertexes of the outer frame correspond to the correction target points 31 through 34. The midpoints of the four sides of the outer frame correspond to the correction target points 35 through 38. It should be noted that the first projection area 30 has a rectangular shape in FIG. 4A, an X axis is defined in parallel to a long axis thereof, and a Y axis is defined in parallel to a short axis. On that basis, a direction from the correction target point 32 toward the correction target point 33 is defined as a +X direction, and a direction from the correction target point 33 toward the correction target point 32 is defined as a −X direction. Further, a direction from the correction target point 32 toward the correction target point 31 is defined as a +Y direction, and a direction from the correction target point 31 toward the correction target point 32 is defined as a −Y direction. It should be noted that in the following description, the +X direction and the −X direction are collectively referred to as a “horizontal direction.” Further, the +Y direction and the −Y direction are collectively referred to as a “vertical direction.” At the correction target point 31 as the vertex of the first projection area 30, there are displayed the icon 31H representing the fact that the correction direction is the horizontal direction, and the icon 31V representing the fact that the correction direction is the vertical direction as the icons representing the correction direction of that correction target point 31. Regarding each of the correction target points 32 through 34 as other vertexes, there are similarly displayed the icons 32H through 34H representing the fact that the correction direction is the horizontal direction, and the icons 32V through 34V representing the fact that the correction direction is the vertical direction. Further, at the correction target point 35 as the midpoint of the side extending in the vertical direction of the first projection area 30, there is displayed the icon 35H representing the fact that the correction direction is the horizontal direction as the icon representing the correction direction of that correction target point 35. Similarly, at the correction target point 37 as the midpoint of the side extending in the vertical direction of the first projection area 30, there is displayed the icon 37H representing the fact that the correction direction is the horizontal direction as the icon representing the correction direction of that correction target point 37. Further, at the correction target point 36 as the midpoint of the side extending in the horizontal direction of the first projection area 30, there is displayed an icon 36H representing the fact that the correction direction is the vertical direction as the icon representing the correction direction of that correction target point 36. Similarly, at the correction target point 38 as the midpoint of the side extending in the horizontal direction of the first projection area 30, there is displayed an icon 38H representing the fact that the correction direction is the vertical direction as the icon representing the correction direction of that correction target point 38. It should be noted that in FIG. 4A, a projection image 39 based on the first image is projected by the projector 20 so as to be inscribed on the first projection area 30.

The user of the information processing system 1 selects one of these icons to thereby designate the correction direction of any one of the correction target points. Subsequently, the user designates a correction amount of that correction target point.

As shown in FIG. 4B, when the user selects the icon 37H by, for example, clicking a mouse, the icon 37H becomes, for example, an outlined white icon, and is highlighted. The icon 37H is displayed at the correction target point 37 as the midpoint of the side extending in the vertical direction of the first projection area 30.

Thus, as shown in FIG. 4C, the correction target point 37 comes to be able to move only on an axis represented by the dotted line. Subsequently, by the user, for example, dragging the mouse while keeping the clicked state, the side extending in the vertical direction on which the correction target point 37 is set moves in the horizontal direction. As a result, the first projection area 30 deforms into a second projection area 40A.

Further, as shown in FIG. 4D, when the user selects the icon 34H by, for example, clicking a mouse, the icon 34H becomes, for example, an outlined white icon, and is highlighted. The icon 34H is displayed at the correction target point 34 as the vertex of the first projection area 30.

Thus, as shown in FIG. 4E, the correction target point 34 comes to be able to move only on the side extending in the horizontal direction in which the correction target point 34 is included. Subsequently, by the user, for example, dragging the mouse while keeping the clicked state, the correction target point 34 moves in the horizontal direction, and the first projection area 30 deforms into a second projection area 40B.

Further, as shown in FIG. 4F, when the user selects the icon 34V, which is displayed at the correction target point 34 as the vertex of the first projection area 30, and which represents the fact that the correction direction is the vertical direction, by, for example, clicking a mouse, the icon 34V becomes, for example, an outlined white icon, and is highlighted.

Thus, as shown in FIG. 4G, the correction target point 34 comes to be able to move only on the side extending in the vertical direction in which the correction target point 34 is included. Subsequently, by the user, for example, dragging the mouse while keeping the clicked state, the correction target point 34 moves in the horizontal direction, and the first projection area 30 deforms into a second projection area 40C.

It should be noted that when moving the correction target points 31 through 38, it is possible for the display control section 128 described later to stop displaying the icons 31H through 34H, 31V through 34V, 35H, 36V, 37H, and 38V as shown in FIG. 4C, FIG. 4E, and FIG. 4G, but this is not a limitation, and it is possible for the display control section 128 to display the icons. Further, there are no specific indications of the correction target points 31 through 38 using, for example, icons in particular in FIG. 4A, FIG. 4B, FIG. 4D, and FIG. 4F, but the specific indications of the correction target points 31 through 38 can be made, but are not required.

Further, it is favorable for the correction target points 31 through 38, and the icons 31H through 34H, 31V through 34V, 35H, 36V, 37H, and 38V to be displayed based on a still image at a moment when the imaging device 110 starts the imaging of the projection surface on which the projection is performed by the projector 20, but this is not a limitation.

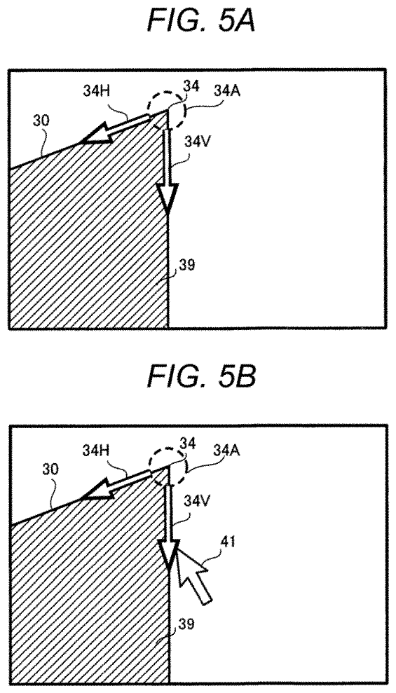

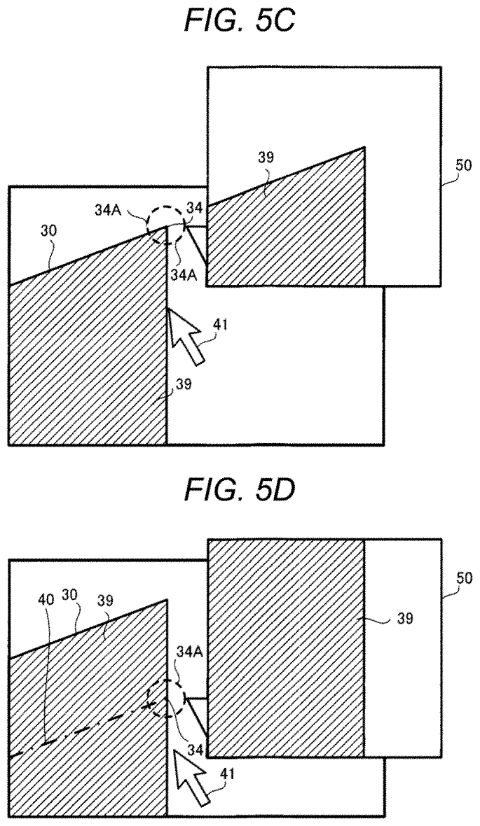

FIG. 5A through FIG. 5E each show an enlarged view in the vicinity of the correction target point in the first adjusting image and the second adjusting image illustrated in FIG. 4A through FIG. 4G. It should be noted that in FIG. 5A through FIG. 5E, there is shown an enlarged view in the vicinity of the correction target point 34 as an example, but this is illustrative only, and the same applies to other correction target points.

FIG. 5A is an enlarged view in the state in which the user has not yet performed the operation in the first adjusting image. First, as shown in FIG. 5B, the user of the information processing system 1 selects the icon 34V with an arrow icon 41 provided to a user interface using, for example, the mouse in the first adjusting image, and then clicks the mouse.

Then, as shown in FIG. 5C, the icon 34H and the icon 34V vanish, and at the same time, there is displayed a thumbnail screen 50 obtained by enlarging an inside of a circle represented by an icon 34A.

As shown in the second adjusting image in FIG. 5D, it becomes possible to vertically move the correction target point 34 with the vertical motion of the mouse during the period in which the user keeps on clicking the mouse. Further, a second projection area 40 on the projection surface is displayed based on the correction target point 34 which has vertically been moved. In FIG. 5D, the second projection area 40 is represented by a dashed-dotted line.

Lastly, when the user releases the click of the mouse, the translation of the correction target point 34 is fixed as shown in the second adjusting image in FIG. 5E. Subsequently, a projection image 39A based on the second image which is generated by deforming the first image is displayed in the second adjusting image as described later in accordance with the second projection area 40 as a new projection area. Due to the above, at the correction target point 34, there are displayed the icon 34H and the icon 34V once again similarly to FIG. 5A.

Subsequently, as described later, the second image generated by deforming the first image is output to the projector 20, and the projector 20 projects the second projection image generated based on the second image on the screen, the wall, or the like.

It should be noted that it is possible to adopt a configuration in which the translation of the correction target point 34 is fixed by clicking, for example, a “decision” button shown in the user interface instead of the release of the click of the mouse by the user, and the projection image 39A based on the second image obtained by deforming the first image is displayed in the second adjusting image in accordance with the second projection area as the new projection area.

It should be noted that a projection limit area 42 is specifically indicated by a dashed-two dotted line in FIG. 5E. The projection limit area 42 is an area which the second projection area 40 cannot exceed, and the projection image based on the second image generated by the second image generation section 126 described later cannot be projected beyond the projection limit area 42. In other words, the projection limit area 42 is for limiting a range in which the user can move the correction target point 34 in the second adjusting image.

The coordinates (x_{LT}^{c}, y_{LT}^{c}), (x_{RT}^{c}, y_{LT}^{c}), (x_{RB}^{c}, y_{LT}^{c}), and (x_{LB}^{c},y_{LT}^{c}) of the four corners on the camera image of the projection limit area 42 are calculated by the following formula [2] using the projective transform matrix H included in the formula [1], and the coordinates (x_{LT}^{p}, y_{LT}^{p})=(0, 0), (x_{RT}^{p},y_{RT}^{p})=(Wₚ,0), (x_{RB}^{p},y_{RB}^{p})=(Wₚ,Hₚ), (x_{LB}^{p},y_{LB}^{p})=(0,Hₚ) of the four corners of the projection limit on the panel when defining a panel horizontal resolution Wₚ and a panel vertical resolution Hₚ at the projection of the panel image.

$$( \begin{matrix}{x}_{LT}^{c} & {x}_{RT}^{c} & {x}_{RB}^{c} & {x}_{LB}^{c} \\ {y}_{LT}^{c} & {y}_{RT}^{c} & {y}_{RB}^{c} & {y}_{LB}^{c} \\ 1 & 1 & 1 & 1\end{matrix} ) = s ( \begin{matrix}{h}_{11} & {h}_{12} & {h}_{13} \\ {h}_{21} & {h}_{22} & {h}_{23} \\ {h}_{31} & {h}_{23} & {h}_{33}\end{matrix} ) ( \begin{matrix}0 & {W}_{p} & {W}_{p} & 0 \\ 0 & 0 & {H}_{p} & {H}_{p} \\ 1 & 1 & 1 & 1\end{matrix} ) \qquad [ 2 ]$$

The projection area detection section 123 described above outputs the coordinates of the four corners on the camera image of the projection limit area 42 calculated using the formula [2] described above to the second adjusting image generation section 125, and the second adjusting image generation section 125 sets the projection limit area 42 on the second adjusting image using the coordinates of the four corners on the camera image of that projection limit area 42.

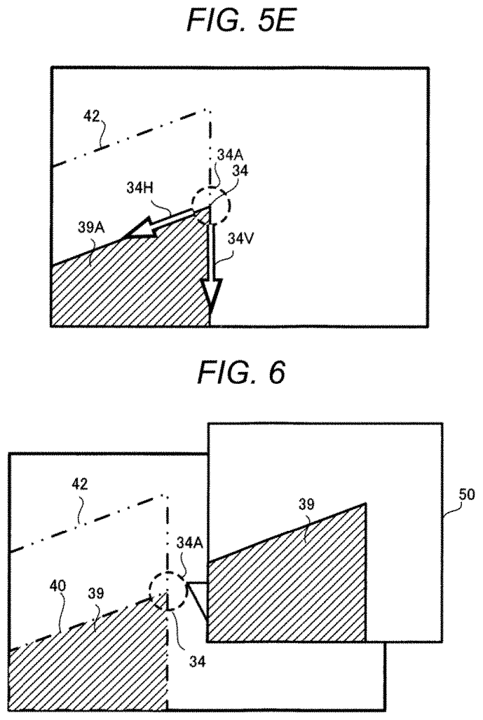

FIG. 6 shows an enlarged view of the second adjusting image as another method. As shown in FIG. 6, in addition to the fact that the second projection area 40 continues to be displayed during the period in which the user keeps on clicking the mouse, it is possible for the deformation of the projection image 39 to sequentially be performed during the translation of the correction target point 34. This can be realized by, for example, sequentially simulating what shape the second image generated by the second image generation section 126 as described later has on the camera coordinate system. Thus, an intuitive operation by the user becomes possible.

It should be noted that when using the adjusting image shown in FIG. 6 as the second adjusting image, it is favorable for the imaging device 110 to be fixed, but this is not a limitation. In particular, when sequentially simulating what shape the second image generated by the second image generation section 126 has in the camera coordinate system using data related to a positional relationship between the imaging device 110 and the projector 20, it is not necessary to take the fact that the imaging device 110 is fixed as an essential requirement.

When the second image generation section 126 receives an instruction of moving one of the correction target points with respect to an icon or a plurality of icons in the first adjusting image, the second image generation section 126 generates the second image based on the position of the one of the correction target points which has been moved. Specifically, when the second image generation section 126 receives the instruction of moving the correction target points 31 through 38 with respect to the icons 31H through 34H, 31V through 34V, 35H, 36V, 37H, and 38V, the second image generation section 126 generates the second image based on the positions of the correction target points 31 through 38 having been moved.

More particularly, it is assumed that in the first adjusting image, the instruction of moving a certain correction target point is received, and at the same time, the interest point p_{N}^{c} having the coordinate (x_{N}^{c}, y_{N}^{c}) in the camera image coincides with the correction target point in the formula [1]. In this case, the components (x_{N}^{c},y_{N}^{c},1) in the N-th column are changed in the matrix on the left-hand side of the formula [1] on one side, and no change occurs in the matrix representing the coordinates of the interest points of the panel image on the right-hand side on the other hand. Therefore, by using the formula [1], a new projective transform matrix H′ is calculated. Subsequently, using a method including a step of multiplying the coordinate corresponding to each of the pixels on the camera image by an inverse matrix H′⁻¹ of the new projective transform matrix H′, the panel image as the second image is generated.

In order to distinguish the inverse matrix H′⁻¹ of the projective transform matrix H′ as the parameter used when generating the second image from the inverse matrix H⁻¹ of the projective transform matrix H representing the correspondence relationship between the panel image as the first image having been output to the projector at first and the camera image, the parameter representing the correspondence relationship is called a “first parameter” and the parameter used for generating the second image is called a “second parameter” in some cases in the present specification.

The second image output section 127 outputs the second image generated by the second image generation section 126 to the projector 20.

The display control section 128 makes the display device 140 display the first adjusting image generated by the first adjusting image generation section 124, and the second adjusting image generated by the second adjusting image generation section 125. In addition to the above, it is possible for the display control section 128 to switch between display and non-display of the variety of icons in accordance with the operation by the user.

### 1-3: Configuration of Projector

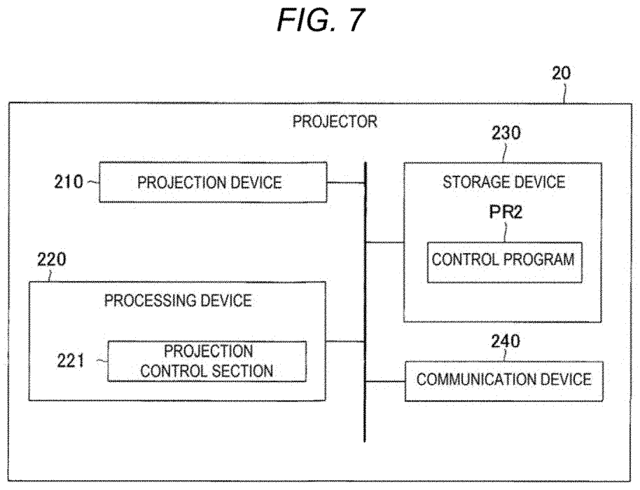

FIG. 7 is a block diagram showing a configuration of the projector 20. The projector 20 is provided with a projection device 210, an operation device 220, a storage device 230, and a communication device 240. The constituents of the projector 20 are coupled to each other with a single bus or a plurality of busses for communicating information. Further, the constituents of the projector 20 are each constituted by a single apparatus or a plurality of apparatuses, and some of the constituents of the projector 20 can be omitted.

The projection device 210 is a device for projecting a first projection image generated described later based on the first image obtained from the information processing device 10, and a second projection image generated based on the second image obtained from the information processing device 10 on the screen, the wall, or the like using a projection control section 221 described later. The projection device 210 includes, for example, a light source, a liquid crystal panel, and a projection lens, modulates light from the light source using a liquid crystal panel, and projects the light thus modulated on the screen, the wall, or the like via the projection lens.

The processing device 220 is a processor for controlling the whole of the projector 20, and is constituted by, for example, a single chip or a plurality of chips. The processing device 220 is formed of a central processing device (CPU: Central Processing Unit) including, for example, an interface with peripheral devices, an arithmetic device, and registers. It should be noted that some or all of the functions of the processing device 220 can also be realized by hardware such as a DSP (Digital Signal Processor), an ASIC (Application Specific Integrated Circuit), a PLD (Programmable Logic Device), or an FPGA (Field Programmable Gate Array). The processing device 220 executes a variety of types of processing in parallel or in sequence.

The storage device 230 is a recording medium which can be read by the processing device 220, and stores a plurality of programs including a control program PR2 to be executed by the processing device 220. The storage device 230 can be formed of at least one of, for example, a ROM (Read Only Memory), an EPROM (Erasable Programmable ROM), an EEPROM (Electrically Erasable Programmable ROM), or a RAM (Random Access Memory). The storage device 230 can be called a register, a cache, a main memory, a main storage unit, and so on.

The communication device 240 is hardware as a transmitting and receiving device for performing communication with other devices. In particular, in the present embodiment, the communication device 240 is a communication device for connecting the projector 20 to the information processing device 10 with wire or wirelessly. The communication device 240 is also called, for example, a network device, a network controller, a network card, and a communication module.

The processing device 220 retrieves the control program PR2 from the storage device 230 to execute the control program PR2 to thereby function as the projection control section 221. It should be noted that the control program PR2 can be transmitted from another device such as a server for managing the projector 20 via a communication network not shown.

The projection control section 221 generates the first projection image based on the first image obtained from the information processing device 10, and then makes the projection device 210 project the first projection image to the wall, the screen, or the like. Further, the projection control section 221 generates the second projection image based on the second image obtained from the information processing device 10, and then makes the projection device 210 project the second projection image to the wall, the screen, or the like.

### 1-4: Operation of Information Processing System 1

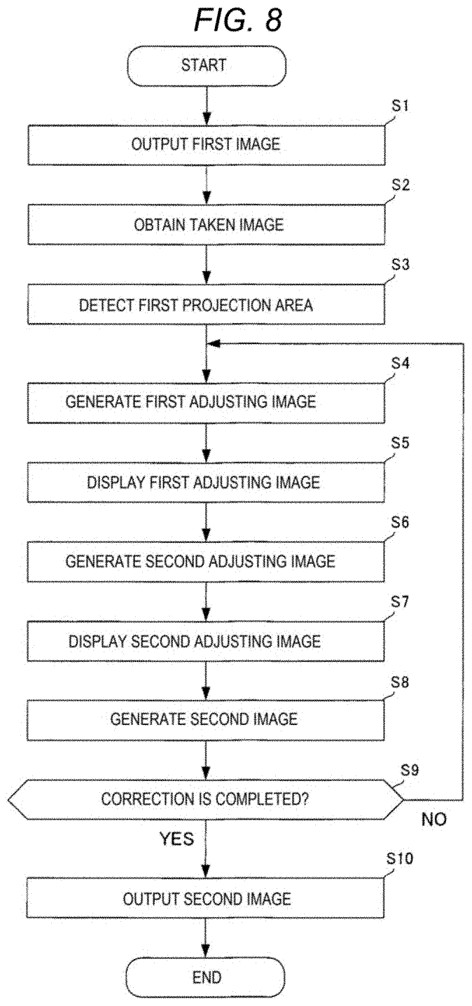

Then, an operation of the information processing system 1 will be described. FIG. 8 is a flowchart showing an example of the operation of the information processing system 1.

First, the first image output section 121 outputs (step S1) the first image to the projector 20. In response thereto, the projector 20 generates the projection image based on the first image, and then projects the projection image on the projection surface such as the wall or the screen.

Then, the taken image acquisition section 122 makes the imaging device 110 take an image of the projection surface on which the projection image described above is projected by the projector 20, and then obtains (step S2) the taken image which the taken image acquisition section 122 has made the imaging device 110 take.

The projection area detection section 123 detects (step S3) the first projection area 30 from the taken image obtained by the taken image acquisition section 122.

The first adjusting image generation section 124 generates (step S4) the first adjusting image obtained by superimposing the icons 31H through 34H, 31V through 34V, 35H, 36V, 37H, and 38V on the taken image obtained by the taken image acquisition section 122.

The display control section 128 makes the display device 140 display (step S5) the first adjusting image generated by the first adjusting image generation section 124.

The second adjusting image generation section 125 generates (step S6) the second adjusting image including the second projection area 40 of the projection surface on which the second image generated by the second image generation section 126 is projected.

The display control section 128 makes the display device 140 display (step S7) the second adjusting image generated by the second adjusting image generation section 125.

When the second image generation section 126 receives the instruction of moving the correction target points 31 through 38 with respect to the icons 31H through 34H, 31V through 34V, 35H, 36V, 37H, and 38V, the second image generation section 126 generates (step S8) the second image based on the positions of the correction target points 31 through 38 having been moved.

When this terminates the correction (YES in the step S9), the process proceeds to the step S10. When the correction is not yet terminated (NO in the step S9), the process proceeds to the step S4.

When YES has been determined in the step S9, the second image output section 127 outputs (step S10) the second image output by the second image generation section 126 to the projector 20.

As described hereinabove, according to the present embodiment, there is provided an image generation method including the steps of outputting the first image to the projector 20, obtaining the taken image obtained by imaging the projection surface on which the projection image 39 based on the first image is projected by the projector 20, detecting, from the taken image, the first projection area 30 of the projection surface on which the projection image 39 is projected, generating the first adjusting image which is obtained by superimposing an icon or a plurality of icons on the taken image, wherein the icon or the plurality of icons are disposed so as to correspond to one of the correction target points on the contour of the first projection area 30, and represent the correction direction of the one of the correction target points, making the display device 140 display the first adjusting image, and generating the second image based on the position of the one of the correction target points which has been moved when the instruction of moving the one of the correction target points with respect to an icon or a plurality of icons is received.

In particular, according to the present embodiment, the information processing device 10 displays the first adjusting image obtained by superimposing an icon or a plurality of icons representing the correction direction of one of the correction target points on the taken image taken by the information processing device 10 using the display device 140 provided to the information processing device 10. Further, the information processing device 10 generates the second image based on the position of the correction target point which has been moved when the information processing device 10 receives the instruction of moving the correction target point in the first adjusting image. Thus, it becomes possible to correct the projection image to be projected from the projector 20 while checking the projection state reflecting the correction on the projection surface. Therefore, it becomes unnecessary to visually check the state of the projection surface on which the projection image is projected from the projector 20.

Further, when the first projection area has a quadrangular shape, and the correction target points are also set on the sides in addition to the four corners of the quadrangle, it becomes possible to reduce the adjustment man-hour for the correction compared to when individually moving each of the two points at the both ends of each of the sides when correcting the positions of the sides.

Further, when each of the icons disposed so as to correspond to one of the correction target points, or one of the icons disposed so as to correspond to one of the correction target points represents the correction direction toward a single direction, since the translation of the correction target point is allowed only on a single axis, it is possible to reduce erroneous operations, and thus, it becomes possible to perform an accurate correction.

Further, when generating the second adjusting image including the second projection area 40, it becomes possible to display the projection limit area 42, the first projection area 30, and the second projection area 40 superimposed on the taken image on the display device 140 when performing the correction.

### 2. Second Embodiment

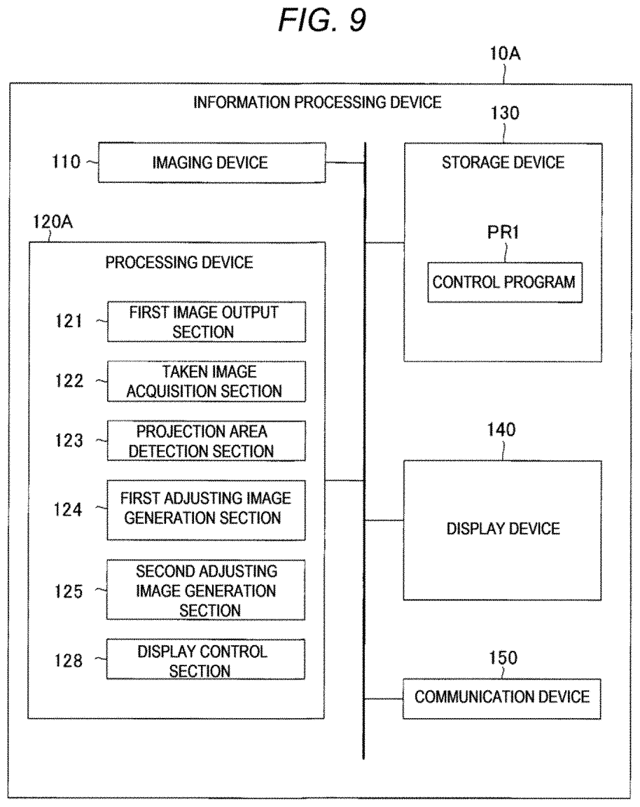

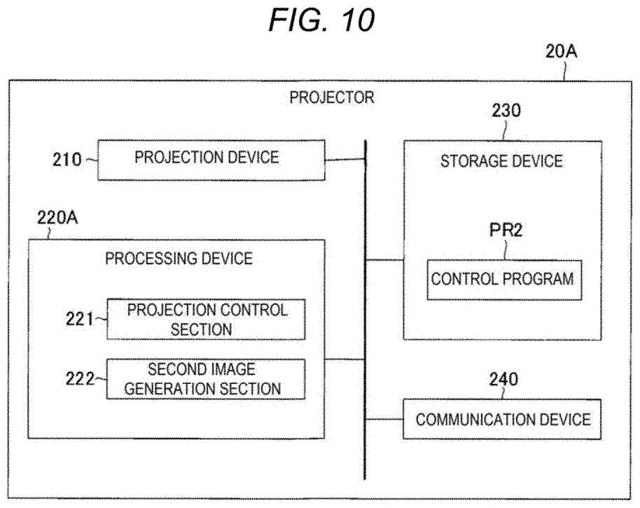

An information processing system 1A according to the present embodiment is hereinafter described with reference to FIG. 9 and FIG. 10. It should be noted that compared to the information processing system 1, the information processing system 1A has substantially the same overall configuration as the information processing system 1 except the point that an information processing device 10A is provided instead of the information processing device 10, and a projector 20A is provided instead of the projector 20, and therefore, the illustration of the overall configuration will be omitted. Further, hereinafter, the point in which the information processing system 1A is different from the information processing system 1 will mainly be described, the same constituents are denoted by the same reference symbols, and the detailed description thereof will be omitted for the sake of simplification of the explanation.

### 2-1. Configuration of Information Processing Device

FIG. 9 is a block diagram showing a configuration example of the information processing device 10A. Unlike the information processing device 10, the information processing device 10A is provided with a processing device 120A instead of the processing device 120. Unlike the processing device 120, the processing device 120A does not require the second image generation section 126 and the second image output section 127 as essential constituents.

### 2-2. Configuration of Projector

FIG. 10 is a block diagram showing a configuration example of the projector 20A. Unlike the projector 20, the projector 20A is provided with a processing device 220A instead of the processing device 220. Unlike the processing device 220, the processing device 220A is provided with a second image generation section 222 in addition to the projection control section 221.

Similarly to the second image generation section 126 of the information processing device 10 in the first embodiment, when the second image generation section 222 receives the instruction of moving one of the correction target points with respect to an icon or a plurality of icons in the first adjusting image described above, the second image generation section 222 generates the second image described above based on the position of the one of the correction target points which has been moved. Further, the second image generation section 222 outputs the second image thus generated to the projection control section 221.

In other words, when comparing the information processing system 1A according to the present embodiment with the information processing system 1 according to the first embodiment, there is a difference that the second image is generated in the projector 20A in the present embodiment while the second image is generated in the information processing device 10 in the information processing system 1.

According to the present embodiment, by the processing device 220A of the projector 20A functioning as the second image generation section 222, it becomes unnecessary to generate the second image at the information processing device 10A. Thus, in the present embodiment, it becomes possible to reduce a burden on the information processing device 10A.

### 3. Modified Examples

It should be noted that the present disclosure is not limited to the embodiments illustrated hereinabove. Specific aspects of modification will hereinafter be illustrated.

### 3-1. Modified Example 1

It is assumed that the taken image acquisition section 122 obtains the taken image taken by the imaging device 110, and the projection area detection section 123 detects the first projection area of the projection surface on which the projection image is projected from the taken image obtained by the taken image acquisition section 122, but this is not a limitation. For example, it is possible for the projection area detection section 123 to simulate the taken image described above using the panel image as the first image to be output to the projector 20, and data based on the positional relationship between the imaging device 110 and the projector 20, and then detect the first projection area from the taken image thus simulated.

### 3-2. Modified Example 2

The information processing device 10 is provided with the second image generation section 126 in the information processing system 1 in the first embodiment while the projector 20A is provided with the second image generation section 222 in the information processing system 1A according to the second embodiment, but this is not a limitation. For example, it is possible to adopt a configuration in which both of the information processing device 10 or 10A and the projector 20 or 20A are provided with the second image generation section. Specifically, it is possible to adopt a configuration in which the information processing device 10 or 10A generates the second image based on the correction to the first image and the first projection area, and then, the projector 20 or 20A further applies a correction to the second image in a superimposed manner to thereby generate a third image, and then the projection image based on the third image is projected on the projection surface.

What is claimed is:

1. An image generation method comprising:
outputting a first image to a projector;
obtaining a taken image by imaging a projection surface on which a projection image based on the first image is projected by the projector;
determining, from the taken image, a first projection area of the projection surface on which the projection image is projected;
generating a first adjusting image obtained by superimposing one or more icons representing a correction direction of a correction target point on a contour of the first projection area on the taken image;
displaying the first adjusting image by a display device; and
generating a second image based on a second position when an instruction of moving the correction target point from a first position to the second position with respect to the one or more icons is received.

2. The image generation method according to claim 1, further comprising:
generating the first image by image processing using a first parameter based on the first position; and
generating a second parameter for the image processing based on the second position, wherein
the generating the second image includes generating the second image with the image processing using the second parameter.

3. The image generation method according to claim 1, further comprising:
outputting the second image to the display device.

4. The image generation method according to claim 3, further comprising:
displaying, by the display device, a second adjusting image including a second projection area obtained by correcting the first projection area based on the second position.

5. The image generation method according to claim 3, wherein
the first projection area has a quadrangular shape, and the correction target point is set at a vertex of the first projection area.

6. The image generation method according to claim 5, wherein
the one or more icons are a plurality of icons corresponding to the target point set at the vertex of the first projection area, and
the plurality of icons represent respective correction directions different from each other.

7. The image generation method according to claim 1, wherein
the first projection area has a quadrangular shape, and
a plurality of the correction target points are set on four sides of the first projection area.

8. The image generation method according to claim 7, wherein
an icon of the one or more icons corresponding to one of the correction target points represents a correction direction.

9. An information processing device comprising:
a processor programmed to execute
outputting a first image to a projector,
obtaining a taken image by imaging a projection surface on which a projection image based on the first image is projected by the projector,
determining, from the taken image, a first projection area of the projection surface on which the projection image is projected,
generating a first adjusting image obtained by superimposing one or more icons representing a correction direction of one of correction target points on a contour of the first projection area on the taken image,
displaying the first adjusting image by a display device,
generating a second image based on a second position when an instruction of moving the one of the correction target points from a first position to the second position with respect to the one or more icons is received, and
outputting the second image to the projector.
